(19) United States
(12) Patent Application Publication
(10) Pub. No.: US 2006/0272211 A1
(43) Pub. Date: Dec. 7, 2006

(54) Easy tilt and drain flower pot ("ET & DFP")

(76) Inventor: Jerome Lee Motelow, New York, NY (US)

Correspondence Address: Jerome L Motelow, 1619 3RD AVE, New York, NY, 10128, US

(21) Appl. No.: 11/437,175

(22) Filed: May 19, 2006

Related U.S. Application Data
(60) Provisional application No. 60/687,020, filed on Jun. 3, 2005.

(51) Int. Cl. A01G 9/02

(52) U.S. Cl. 47/79

(57) ABSTRACT

A device for improved cultivation and easier maintenance of pot-grown plants in the home or commercial garden centers. The plant root system is raised above the interior bottom water well. No matter how much water is applied, the pot prevents plants from drowning using side drain spouts, maintains airflow around the root system, encourages healthier growth, and eliminates unsightly water stains on the surface under the pot. It can be adapted as a cachepot to existing pots without repotting the plant.

This application Claims Priority of provisional application No. 60/687,020 File date Jun. 3, 2005

### BACKGROUND OF THE INVENTION

Flower pots have been in use for many centuries. A design for a more effective flower pot came to me after formal study of horticulture at SUNY NY and many years of personal experience of raising house plants and orchids. In addition to light and temperature, the moisture level of the soil or planting medium is among the most important factor in a plant's growth and health. Whereas light and temperature conditions are easily ascertained, however it is often difficult for the plant's caretaker to assess the appropriate amount of water to give the plant. Thus many houseplants fail as a result of to much or to little water. The special Design of the Easy Tilt and Drain Flower Pot addresses this problem by helping to optimize water levels, as well as making easier for the caretaker to determine how much additional moisture is necessary, so the plant is less likely to fail due to over watering.

### DESCRIPTION OF THE INVENTION

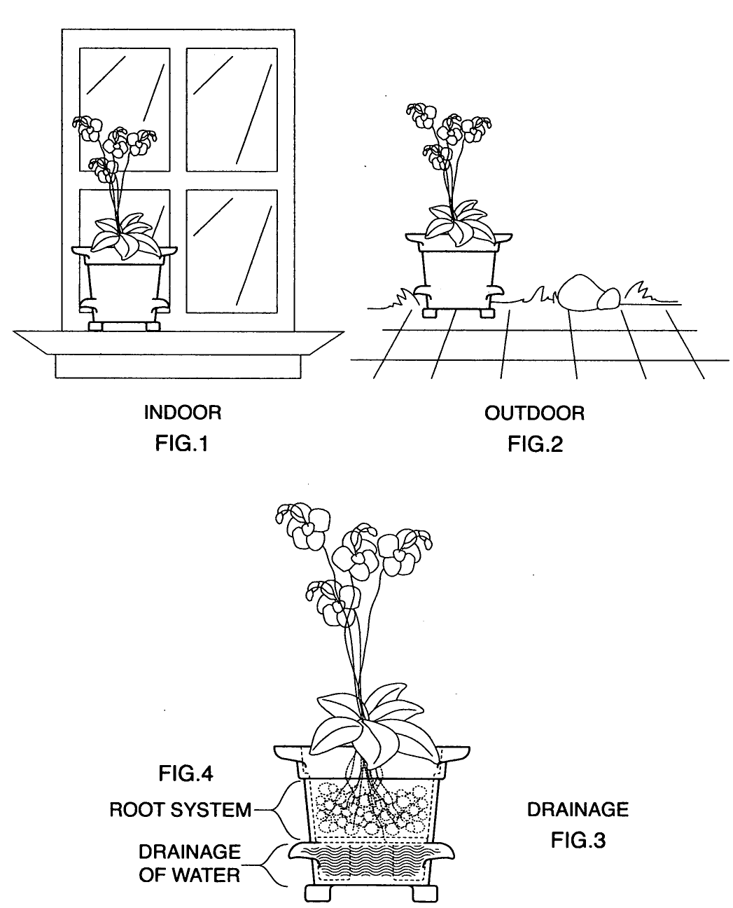

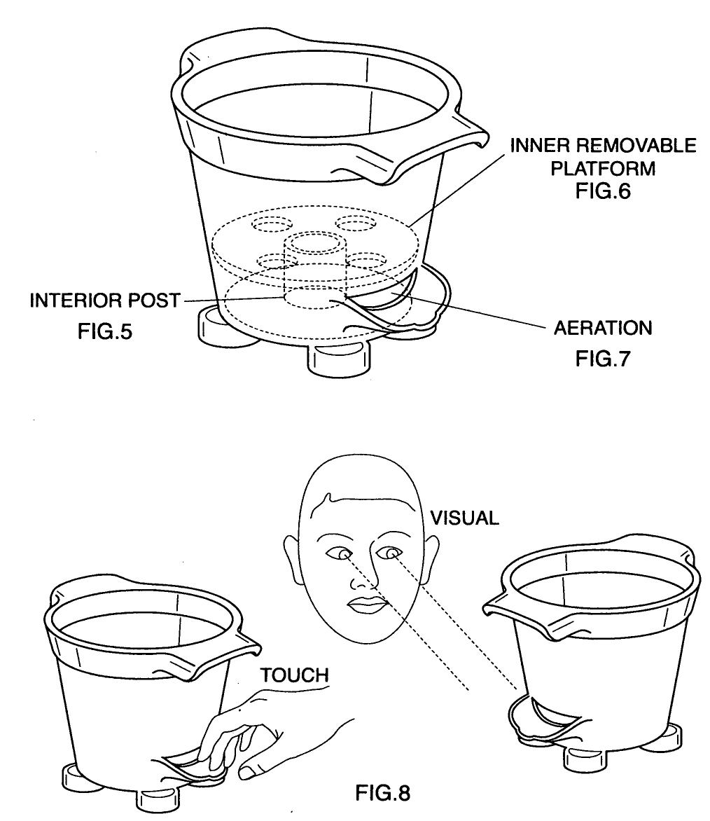

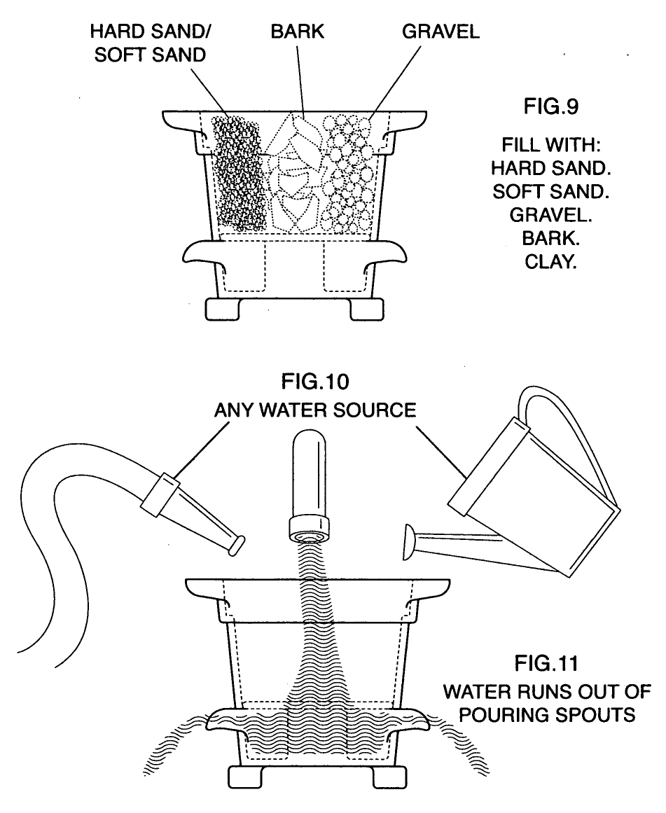

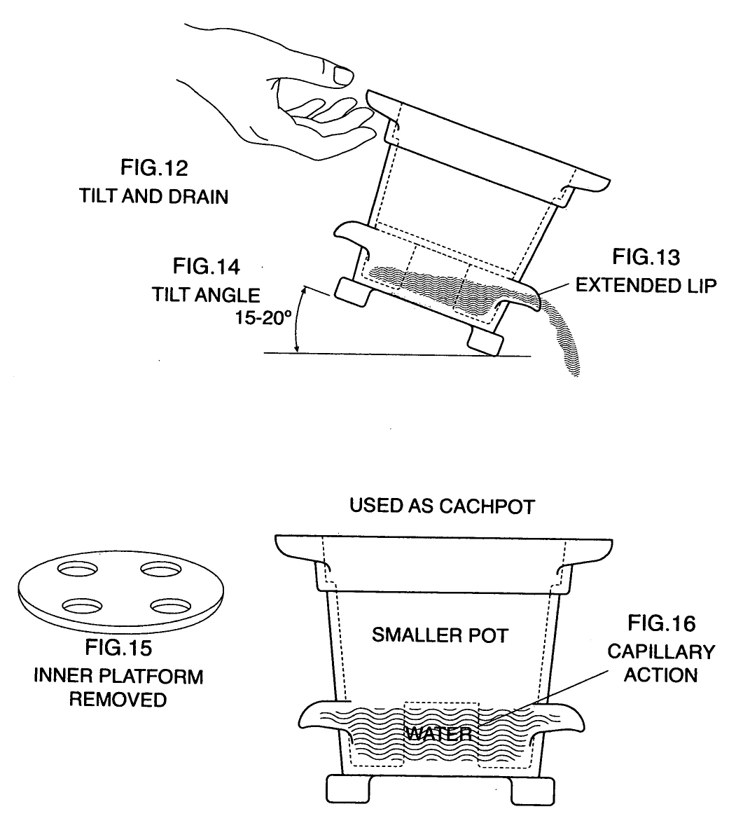

This all-in-one container pot that accommodates the changing needs of house plants indoor (FIG. 1), and outdoor (FIG. 2). This includes commercially-grown plants, such as orchids, that need an evolving drainage environment as they grow (FIG. 3). The ET&DFP allows for optimal drainage by raising the plant's root system above the drainage well (FIG. 4), eliminating the need for a saucer to collect excess water. The plant is supported by an interior post (FIG. 5), which raises the root ball and supports it with a platform that rests on the interior post (FIG. 6). Raising the roots allows better drainage, prevents over-watering, root rot, and improves aeration of potted plants, simulating an ideal natural environment (FIG. 7). A visual check or finger touch to assess saturation level (FIG. 8), in conjunction with consideration of the soil condition (e.g., hard, soft, gravel, pellets, clay, bark), allows for creation of a regular watering schedule. (FIG. 9). The ET&DFP can be put directly under a running water source (FIG. 10) without over-watering or spillage of soil or planting medium, as excess water runs out of the two side pouring spouts (FIG. 11). Complete or partial drainage is accomplished by tilting the pot slightly with a left or right hand lip on the top edge of pot rim (FIG. 12). The extended lip of the pour spouts prevent dripping down the side of the pot by allowing the excess water to flow cleanly out of the pot (FIG. 13). The soil loss that occurs when a conventional pot or cachepot is tilted at an extreme angle to drain is not a factor with the ET&DFP's pour angle of 15 or 20 degrees (FIG. 14). When used as a cachepot, the ET&DFP's inner removable platform (FIG. 15) allows extra space for smaller size pots. The smaller pot is supported by the center post and benefits from the capillary action of the ET&DFP pot water well (FIG. 16).

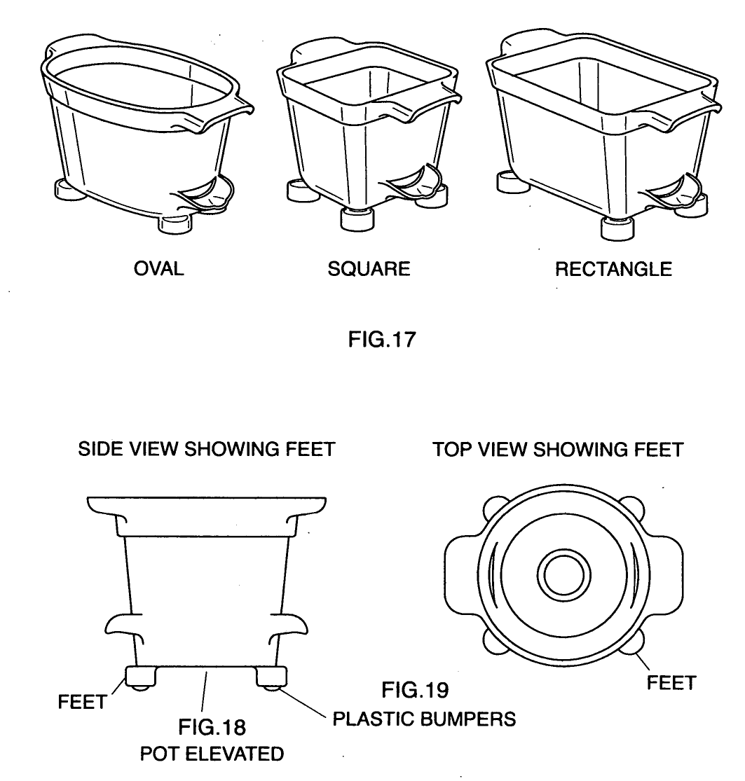

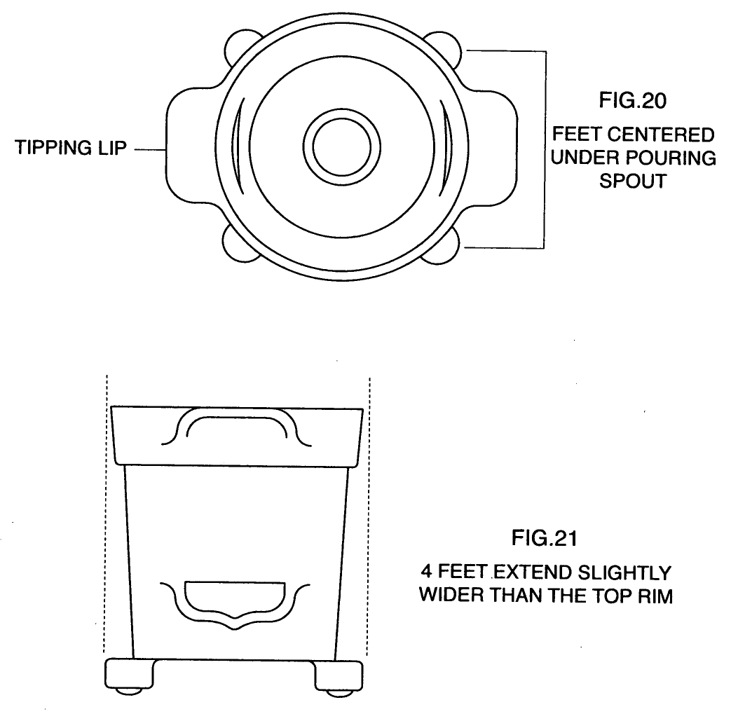

The ET&DFP can be manufactured in any material in which pots are traditionally made such as clay, ceramic (glazed or unglazed), or plastic (fabricated or molded). The shape or size of the ET&DFP can be altered to accommodate a window box shape or any flower pot shape (e.g., circular, oval, square, or rectangular) (FIG. 17). The four supports on the bottom of the base eliminate the common problem of moisture gathering under a saucer or cachepot by elevating the pot slightly (FIG. 18) and affixing bumpers on the bottom of the feet (FIG. 19). The four support feet are strategically placed to straddle either side of the pour spouts making intentional tipping (FIG. 20) easy since the tipping lips on top (FIG. 21) are also directly over the two pouring spouts. The position of the four feet serve also eliminate tipping: the extension of the feet beyond the diameter of the top rim of the pot (FIG. 21), makes the plant more stable when it becomes top heavy, and eliminates an additional repotting of an otherwise healthy plant.

1. A flower pot comprised of at least one pour spout for draining excess water.

2. The flower pot according to claim 1, wherein a second pour spout is located on an opposite side of the pot from the first pour spout.

3. The flower pot according to claim 1 or 2, further including at least four feet located on the bottom of the pot

4. The flower pot according to claim 3, wherein the feet are placed between the angular positions of the pour spouts for increasing the ease of tilting the pot and pouring excess water there from.

5. The flower pot according to claim 3 or 4, further including a lip above each of the two pour spouts which can be used to grip and tilt the pot from either a right-handed or left-handed position, and thereby increasing the ease of tilting the pot and pouring excess water there from.

6. The flower pot according to claim 5, further including a lip, located above each pour spout, that allows excess water from the water well to exit through either pour spout when the pot is tilted.

7. The flower pot according to any one of claims 1 through 6, further including a removable platform, and interior post,
which support the platform that suspends a root system of a plant above the bottom surface of the pot, and creates a drainage well at the bottom area of the pot to accumulate excess water.

8. The flower pot according to claim 7, wherein the platform contains drainage holes.

9. The flower pot according to any one of claims 1 through 8, further including air and root holes within the walls of the pot.

10. The flower pot according to any one of claims 1 through 9,
wherein the flower pot is made from a group of materials including clay or glazed ceramics, and fabricated or molded plastics.

11. The flower pot according to any one of claims 1 through 9,
wherein the flower pot is formed from a group of shapes including oval, circle, square, and rectangular.
